(19) United States
(12) Patent Application Publication
(10) Pub. No.: US 2015/0052396 A1
(43) Pub. Date: Feb. 19, 2015

(54) STATE INFORMATION RECORDING APPARATUS, NON-TRANSITORY COMPUTER READABLE MEDIUM, AND STATE INFORMATION RECORDING METHOD

(71) Applicant: FUJI XEROX CO., LTD., Tokyo (JP)

(72) Inventor: Masahiko HARADA, Kanagawa (JP)

(73) Assignee: FUJI XEROX CO., LTD., Tokyo (JP)

(21) Appl. No.: 14/287,846

(22) Filed: May 27, 2014

(30) Foreign Application Priority Data
Aug. 15, 2013 (JP) 2013-169014

(51) Int. Cl. G06F 11/14

(52) U.S. Cl. CPC G06F 11/1471; G06F 11/1441
USPC 714/20

(57) ABSTRACT

A state information recording apparatus includes a copying section that copies a recording program from a first memory to a second memory, a detector that detects occurrence of a fault in the state information recording apparatus, a determining section that determines whether or not the recording program copied to the second memory is destroyed, in response to detection of occurrence of the fault, a recording section that records the state information to the non-volatile memory, by executing the recording program in the second memory if it is determined that the recording program copied to the second memory is not destroyed, or by executing the recording program stored in the first memory if it is determined that the recoding program copied to the second memory is destroyed, and a reboot section that reboots the state information recording apparatus after the state information is recorded to the non-volatile memory.

### CROSS-REFERENCE TO RELATED APPLICATIONS

This application is based on and claims priority under 35 USC 119 from Japanese Patent Application No. 2013-169014 filed Aug. 15, 2013.

### BACKGROUND

### Technical Field

The present invention relates to a state information recording apparatus, a non-transitory computer readable medium, and a state information recording method.

### SUMMARY

According to an aspect of the invention, there is provided a state information recording apparatus including a copying section that copies a recording program from a first memory to a second memory, the recording program recording state information related to a state of the state information recording apparatus into a non-volatile memory, the first memory being a memory into which the recording program is stored before the recording program is executed, the second memory being a memory into which the recording program is stored when the recording program is executed, a detector that detects occurrence of a fault in the state information recording apparatus, a determining section that determines whether or not the recording program copied to the second memory is destroyed, in response to detection of occurrence of the fault, a recording section that records the state information to the non-volatile memory by one of: executing the recording program in the second memory in a case where it is determined that the recording program copied to the second memory is not destroyed; and executing the recording program stored in the first memory in a case where it is determined that the recoding program copied to the second memory is destroyed, and a reboot section that reboots the state information recording apparatus after the state information is recorded to the non-volatile memory.

### BRIEF DESCRIPTION OF THE DRAWINGS

Exemplary embodiment of the present invention will be described in detail based on the following figures, wherein:

FIG. 1 illustrates an example of the configuration of an image processing apparatus according to an exemplary embodiment of the invention;

FIG. 2 is a block diagram illustrating an example of the functional configuration of an image processing apparatus according to an exemplary embodiment of the invention;

FIG. 3 is a flowchart illustrating an example of operation when program validity information is constructed by an image processing apparatus according to an exemplary embodiment of the invention;

FIG. 4 illustrates a log recording program loaded into a program area of a DRAM by an image processing apparatus according to an exemplary embodiment of the invention;

FIG. 5 illustrates program validity information constructed in a data area of a DRAM by an image processing apparatus according to an exemplary embodiment of the invention;

FIG. 6 is a flowchart illustrating an example of operation when the validity of a program is determined by an image processing apparatus according to an exemplary embodiment of the invention; and

FIG. 7 illustrates data loaded into a SRAM in a case where an image processing apparatus according to an exemplary embodiment of the invention determines to execute a log recording program by a second method when a log recording program is destroyed.

### DETAILED DESCRIPTION

Hereinafter, an exemplary embodiment of the invention will be described in detail with reference to the attached figures.

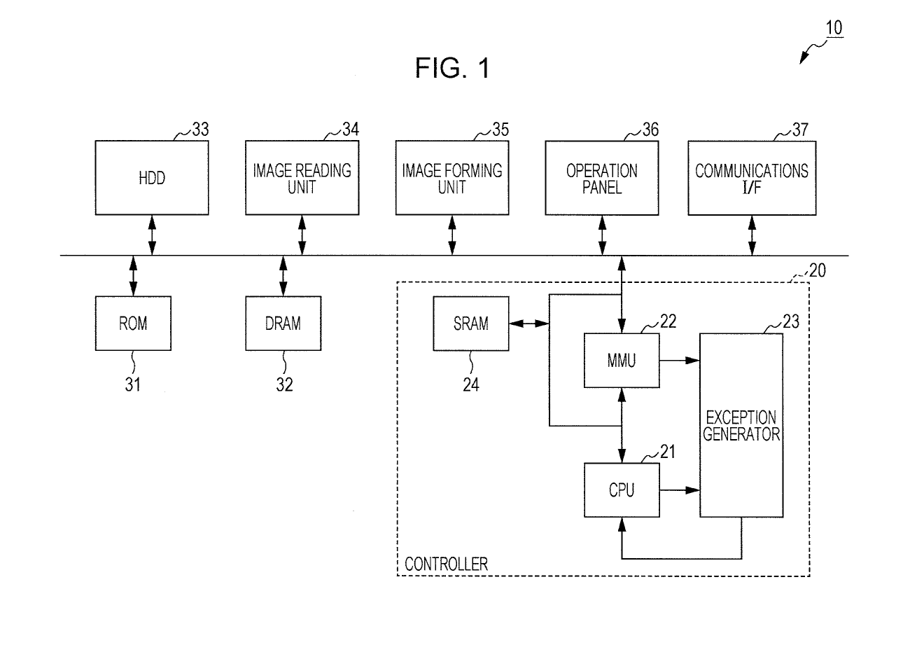

FIG. 1 illustrates an example of the hardware configuration of an image processing apparatus 10 according to the exemplary embodiment.

As illustrated in FIG. 1, the image processing apparatus 10 includes a controller 20 that controls the entire apparatus. The controller 20 is realized by a central processing unit (CPU) 21, a memory management unit (MMU) 22, an exception generator 23, and a static random access memory (SRAM) 24, and the like which are incorporated into a single processor chip by the system-on-a-chip (SoC) method. The image processing apparatus 10 also includes a read only memory (ROM) 31, a dynamic random access memory (DRAM) 32, a hard disk drive (HDD) 33, an image reading unit 34, an image forming unit 35, an operation panel 36, and a communications interface (hereinafter, referred to as “communications I/F”) 37.

The CPU 21 realizes various functions described later by loading various programs stored in the ROM 31 and the like into the DRAM 32 and executing the programs. At that time, if the CPU 21 reads an undefined instruction, the CPU 21 outputs a signal indicating an undefined instruction exception.

The MMU 22 has a page table. In the page table, physical addresses in the DRAM 32 are associated with virtual addresses on a page-by-page basis, and access information indicating whether or not a write is allowed and whether or not a read is allowed is set on a page-by-page basis. The MMU 22 converts a virtual address outputted from the CPU 21 into a physical address by referencing the page table. At that time, if a physical address corresponding to the virtual address does not exist in any of the entries of the page table, or if the virtual address to one for which requested access is inhibited, the MMU 22 outputs a signal indicating a memory access exception.

The exception generator 23 receives a signal indicating an undefined instruction exception outputted by the CPU 21, a signal indicating a memory access exception outputted by the MMU 22, an interrupt request (IRQ), or the like, and outputs an exception generation notification notifying that an exception or an interrupt is generated to the CPU 21.

The SRAM 24 is a memory used as a working memory or the like for the CPU 21. Since the SRAM 24 is faster than the DRAM 32, the SRAM 24 is used as a cache memory in which data read from the DRAM 32 is stored in advance for when the data will be used again.

The ROM 31 is a memory that stores various programs and the like executed by the CPU 21.

The DRAM 32 is a memory used as a working memory or the like for the CPU 21. When the image processing apparatus 10 is booted, various programs stored in the ROM 31 are copied to the DRAM 32.

The HDD 33 is an example of a non-volatile memory. The HDD 33 is, for example, a magnetic disk unit that stores data such as image data read by the image reading unit 34 and image data used for forming an image in the image forming unit 35.

The image reading unit 34 reads an image recorded on a recording medium such as paper. The image reading unit 34 is, for example, a scanner. The scanner used may be one employing a CCD system in which a reflected ray produced by reflection of light radiated to a document from a light source is reduced by a lens and received by a charge coupled device (CCD), or a CIS system in which reflected rays produced by reflection of light rays sequentially radiated to a document from LED light sources are received by a contact image sensor (CIS).

The image forming unit 35 forms an image on a recording medium. The image forming unit 35 is, for example, a printer. The printer used may be one employing an electrophotographic system with which toner deposited on a photoconductor is transferred to a recording medium to form an image, or an ink jet system with which ink is discharged onto a recording medium to form an image.

The operation panel 36 is a touch panel that displays various kinds of information and accepts an input of an operation from the user. The operation panel 36 includes a display on which various kinds of information are displayed, and a position detection sheet that detects a position pointed by a pointing section such as a finger or a stylus pen.

The communications I/F 37 transmits and receives various kinds of information to and from other devices via a network.

Incidentally, in the image processing apparatus 10 configured as described above, the following operation is performed in some cases. That is, when the CPU 21 accesses the DRAM 32, if the MMU 22 detects occurrence of a fault that triggers a system hang such as a memory access exception, the CPU 21 calls an exception handler in response to an exception generation notification from the exception generator 23, and the exception handler executes a log recording program that collects and records a log of state information related to the state of the image processing apparatus 10 (such as the register of the CPU 21 and OS information). Through this operation, state information is displayed on the operation panel 36, or transferred to a host PC (not illustrated) via the communications I/F 37 and displayed on the host PC.

However, the above-mentioned operation is limited to the case where the CPU 21 accesses the DRAM 32. That is, in a case where a bus initiator other than the CPU 21, for example, a direct memory access (DMA) controller accesses the DRAM 32, it may not be possible to perform the above-mentioned operation for the following reason. That is, for example, if DMA goes haywire and destroys the program area of the DRAM 32, the exception handler may not be able to execute the log recording program in some cases.

Accordingly, in the exemplary embodiment, when the CPU 21 accesses the DRAM 32, if the MMU 22 as an example of a detector detects occurrence of a fault, it is determined whether or not the log recording program is destroyed. Then, if the log recording program is not destroyed, the image processing apparatus 10 is rebooted after executing the log recording program normally, and if the log recording program is destroyed, the image processing apparatus 10 is rebooted after executing the log recording program by a special method, or without executing the log recording program.

First to third methods described below are conceivable as examples of the special method for executing the log recording program in a case where a log recording program is destroyed. That is, if a vector table is not destroyed, the image processing apparatus 10 is rebooted while saving a log of state information (a log up to the time immediately before the fault occurs) by any one of the following first to third methods.

In the first method, if the log recording program is destroyed, the log recording program is executed in the ROM 31.

In the second method, if the log recording program is destroyed, the log recording program is copied from the ROM 31 to the SRAM 24 and executed.

In the third method, if the log recording program is destroyed, the log recording program is copied from the ROM 31 to the DRAM 32 again and executed.

A log recording program is an example of a recording program that records state information related to the state of the image processing apparatus 10 to a non-volatile memory. The ROM 31 is an example of a first memory into which the recording program is stored before the recording program is executed. The DRAM 32 is an example of a second memory into which the recording program is stored when the recording program is executed. The SRAM 24 is an example of a third memory that is not affected by destruction of the recording program copied to the second memory.

Next, a configuration of the image processing apparatus 10 that operates as mentioned above will be described.

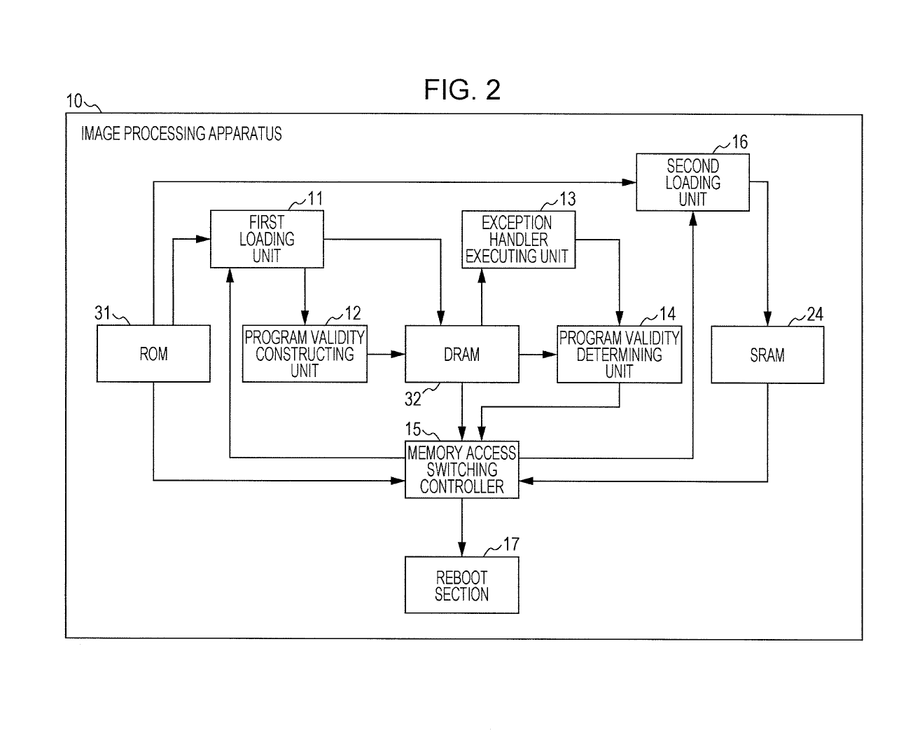

FIG. 2 is a block diagram illustrating an example of the functional configuration of the image processing apparatus 10.

As illustrated in FIG. 2, in addition to the ROM 31, the DRAM 32, and the SRAM 24 mentioned above, the image processing apparatus 10 includes a first loading unit 11, a program validity constructing unit 12, an exception handler executing unit 13, a program validity determining unit 14, a memory access switching controller 15, a second loading unit 16, and a reboot unit 17.

The first loading unit 11 loads programs from the ROM 31 into the program area of the DRAM 32 when the image processing apparatus 10 is booted or at arbitrary timing after the boot. The programs loaded at this time include log recording programs. When it is determined that a log recording program loaded into the program area of the DRAM 32 is destroyed, the first loading unit 11 loads the log recording program from the ROM 31 into the program area of the DRAM 32 again. In the exemplary embodiment, the first loading unit 11 is provided as an example of a copying section that copies a recording program from the first memory to the second memory.

The program validity constructing unit 12 constructs information related to the validity of a log recording program stored in the program area of the DRAM 32 (hereinafter, referred to as “program validity information”) in the data area of the DRAM 32. The validity of a log recording program means that the log recording program operates properly, and that the log recording program is not destroyed.

Accordingly, program validity information may include, for example, a checksum value calculated from a log recording program. Specifically, when a log recording program is loaded from the ROM 31 into the program area of the DRAM 32, the checksum value of the log recording program may be calculated, and the calculated checksum value may be stored into the data area of the DRAM 32. It is to be noted, however, that the calculation of a checksum value may not necessarily be performed at the time when a log recording program is loaded from the ROM 31 into the program area of the DRAM 32. The calculation of a checksum value may be performed prior to occurrence of a fault in the image processing apparatus 10 after a log recording program is loaded from the ROM 31 into the program area of the DRAM 32. That is, a checksum value stored in the data area of the DRAM 32 is an example of first characteristic information computed by a predetermined procedure from a recording program copied to the second memory, prior to detection of occurrence of a fault.

Alternatively, program validity information may include, for example, a timestamp indicative of the time at which a log recording program is written. Specifically, when a log recording program is loaded from the ROM 31 into the program area of the DRAM 32, a timestamp indicative of the time at which the log recording program is written may be stored into the data area of the DRAM 32.

When the exception handler executing unit 13 receives an exception generation notification from the exception generator 23 (see FIG. 1), the exception handler executing unit 13 references a vector in a vector table which corresponds to the exception generation notification, and executes an exception handler stored at an address specified by the vector. Although a vector table is normally used by being copied from the ROM 31 to the DRAM 32, if it is determined that a log recording program loaded into the program area of the DRAM 32 is destroyed, the vector table is used by being copied from the ROM 31 to the SRAM 24 in some cases.

The program validity determining unit 14 determines the validity of a log recording program stored in the program area of the DRAM 32, on the basis of program validity information constructed in the data area of the DRAM 32 by the program validity constructing unit 12.

In a case where program validity information includes a checksum value, the validity of a log recording program may be determined by comparing a checksum value calculated from a log recording program stored in the program area of the DRAM 32, with a checksum value included in the program validity information of the log recording program stored in the data area of the DRAM 32. The checksum value calculated from a log recording program stored in the program area of the DRAM 32 is an example of second characteristic information computed from the recording program copied to the second memory by a predetermined procedure in response to detection of occurrence of a fault. In the exemplary embodiment, the program validity determining unit 14 is provided as an example of a determining section that determines whether or not the recording program copied to the second memory is destroyed.

In a case where program validity information includes a timestamp, the validity of a log recording program may be determined by comparing a timestamp indicative of the time at which a log recording program is written to the program area of the DRAM 32, and a timestamp included in the program validity information of the log recording program stored in the data area of the DRAM 32.

In the case where the program validity information includes a timestamp, presence of different timestamps does not necessarily mean that the log recording program in question is destroyed. Accordingly, in this case, the program validity information is information used for checking whether or not there is a possibility of the log recording program being destroyed. That is, in the exemplary embodiment, the program validity determining unit 14 may be provided as an example of a determining section that determines whether or not there is a possibility of the recording program copied to the second memory being destroyed.

The memory access switching controller 15 determines in which one of the ROM 31, the DRAM 32, and the SRAM 24 a program is to be executed, and on the basis of the determination result, the memory access switching controller 15 switches the memories to be accessed.

Specifically, in a case where a log recording program stored in the program area of the DRAM 32 is not destroyed, the memory access switching controller 15 sets the DRAM 32 as the memory to be accessed, and executes the log recording program in the DRAM 32.

In a case where a log recording program stored in the program area of the DRAM 32 is destroyed, the memory to be accessed varies depending on which one of the first to third methods mentioned above is to be used. In a case where the first method is to be used, the memory to be accessed is set to the ROM 31, and the log recording program is executed in the ROM 31. In a case where the second method is to be used, the memory to be accessed is set to the SRAM 24, and after the second loading unit 16 is caused to load the log recording program from the ROM 31 into the SRAM 24, the log recording program is executed in the SRAM 24. In a case where the third method is to be used, the memory to be accessed is set to the DRAM 32, and after the first loading unit 11 is caused to load the log recording program from the ROM 31 into the DRAM 32 again, the log recording program is executed in the DRAM 32.

Then, when the log recording program is executed in this way, a log of state information related to the state of the image processing apparatus 10 is recorded to the HDD 33 (see FIG. 1).

Which one of the first to third methods is to be used in the case where a log recording program stored in the program area of the DRAM 32 is destroyed may be determined in advance as a setting on the image processing apparatus 10, or may be determined dynamically on the basis of the type of the log recording program stored in the program area of the DRAM 32.

In the exemplary embodiment, the memory access switching controller 15 is provided as an example of a recording section that records state information to the non-volatile memory by one of the following methods: executing the recording program in the second memory in a case where it is determined that the recording program copied to the second memory is not destroyed; and executing the recording program stored in the first memory in a case where it is determined that the recording program copied to the second memory is destroyed.

When it is determined that the log recording program loaded into the program area of the DRAM 32 is destroyed, the second loading unit 16 loads the log recording program from the ROM 31 into the SRAM 24.

The reboot unit 17 reboots the image processing apparatus 10 in a case where the reboot unit 17 receives an exception generation notification from the exception generator 23 (see FIG. 1), after a log of state information related to the state of the image processing apparatus 10 is recorded to the HDD 33 (see FIG. 1) by the memory access switching controller 15 executing the log recording program, or even if a log of state information related to the state of the image processing apparatus 10 is not recorded. In the exemplary embodiment, the reboot unit 17 is provided as an example of a reboot section that automatically reboots the image processing apparatus 10.

Of the functional units mentioned above, functional units other than the ROM 31, the DRAM 32, and the SRAM 24 are realized by cooperation of software and hardware resources. Specifically, these functional units are realized when the CPU 21 (see FIG. 1) reads a program for realizing each of the first loading unit 11, the program validity constructing unit 12, the exception handler executing unit 13, the program validity determining unit 14, the memory access switching controller 15, the second loading unit 16, and the reboot unit 17 from, for example, the ROM 31 to the DRAM 32 and executing the program.

Next, operation of the image processing apparatus 10 according to the exemplary embodiment will be described. The following description will be directed to a case where program validity information includes a checksum value.

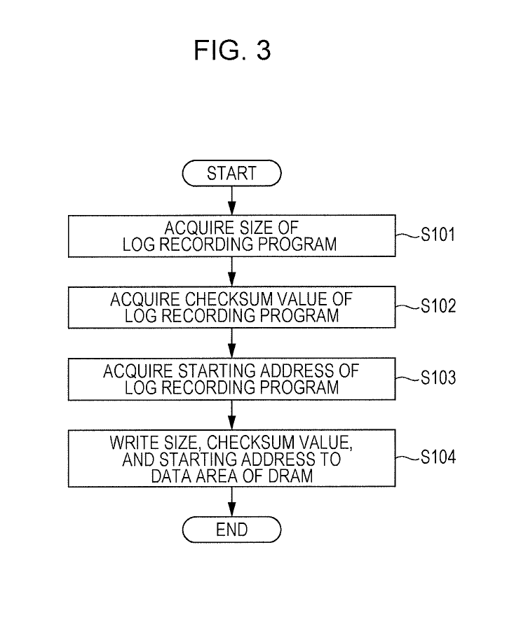

FIG. 3 is a flowchart illustrating an example of operation when the image processing apparatus 10 constructs program validity information. This operation is performed by the program validity constructing unit 12 when the first loading unit 11 loads a log recording program from the ROM 31 into the program area of the DRAM 32.

When the first loading unit 11 reads a log recording program from the ROM 31, the program validity constructing unit 12 acquires the size of the log recording program from the first loading unit 11 (step 101). Since the first loading unit 11 also reads the size of the log recording program which is appended as an attribute when reading the log recording program from the ROM 31, the program validity constructing unit 12 may acquire this size from the first loading unit 11.

At this time, the program validity constructing unit 12 acquires the body of the log recording program from the first loading unit 11, and computes a checksum value from the log recording program (step 102).

Thereafter, when the first loading unit 11 writes the log recording program to the program area of the DRAM 32, the program validity constructing unit 12 acquires the starting address of the log recording program in the DRAM 32 from the first loading unit 11 (step 103). Since the first loading unit 11 recognizes the starting address of the log recording program when writing the log recording program to the DRAM 32, the program validity constructing unit 12 may acquire this starting address from the first loading unit 11.

Accordingly, the program validity constructing unit 12 writes the size acquired in step 101, the checksum value computed in step 102, and the staring address acquired in step 103 to the data area of the DRAM 32, as the program validity information of the log recording program (step 104).

Now, a specific description will be given of how to construct program validity information from a log recording program through the operation illustrated in FIG. 3.

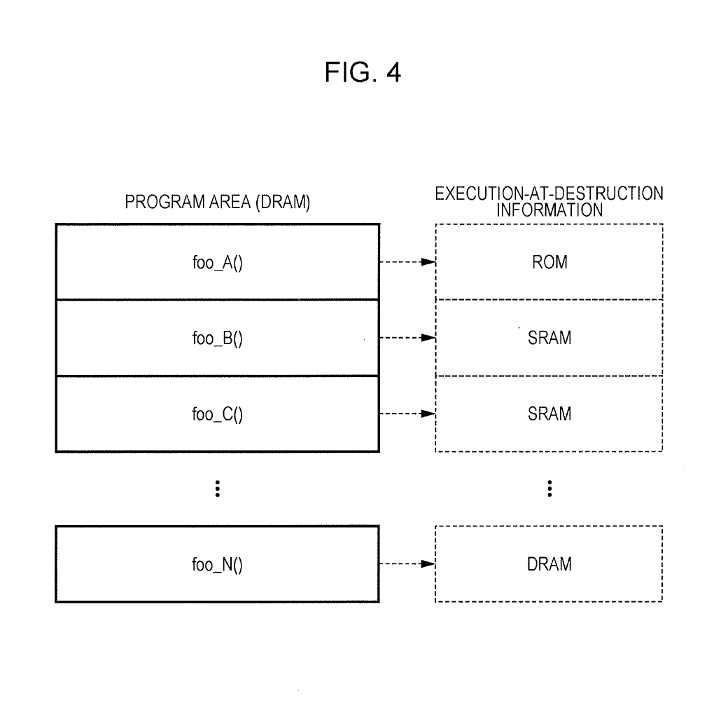

FIG. 4 illustrates log recording programs stored in the program area of the DRAM 32. As illustrated in FIG. 4, log recording programs “foo_A( )”, “foo_B( )”, “foo_C( )” through “foo_N( )” are stored in the program area. That is, in this case, each log recording program is represented by the name of a function called from an exception handler.

Although not necessary for construction of program validity information, information about execution at destruction (hereinafter referred to as “execution-at-destruction information”) is also depicted in FIG. 4. This execution-at-destruction information defines, for each individual log recording program, which one of the first to third methods mentioned above is to be used in executing the log recording program stored in the ROM 31 when the log recording program is destroyed. For example, since the log recording program “foo_A( )” is assumed to be a log recording program having the simplest function, for this log recording program, the execution-at-destruction information defines that the log recording program is to be executed in the ROM 31. This is because the ROM 31 allows the log recording program to operate reliably without being affected by destruction, albeit in an execution environment that places a restriction on the operation of the program. Because the log recording programs “foo_B( )”, “foo_C( )” are assumed to be log recording programs having the second simplest function, for each of these log recording programs, the execution-at-destruction information defines that the log recording program is to be executed in the SRAM 24. This is because the SRAM 24 also allows the log recording program to operate reliably without being affected by destruction, albeit in an execution environment that places a restriction on the operation of the program to some extent. Further, because the log recording program “foo_N( )” is assumed to be a log recording program with a detailed function, for this log recording program, the execution-at-destruction information defines that the log recording program is to be executed in the DRAM 32. While in this example the execution-at-destruction information defines by which one of the first to third methods a log recording program is to be executed, the execution-at-destruction information may also define whether or not to execute a log recording program. Further, the execution-at-destruction information is desirably stored in, for example, the ROM 31 that is not affected by the destruction of the log recording program stored in the program area of the DRAM 32.

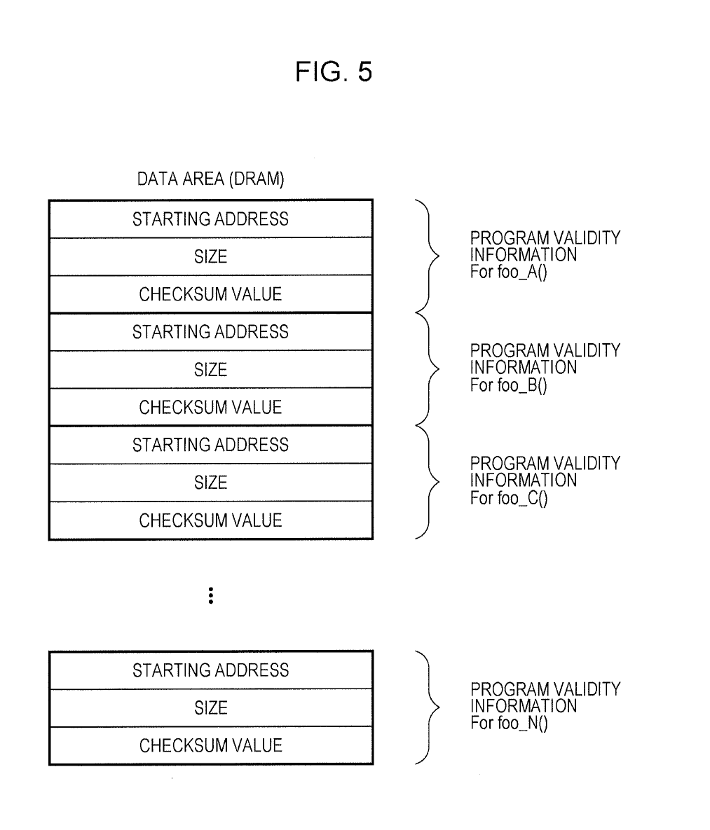

FIG. 5 illustrates program validity information stored in the data area of the DRAM 32. As illustrated in FIG. 5, program validity information about each of the log recording programs “foo_A( )”, “foo_B( )”, “foo_C( )” through “foo_N( )” illustrated in FIG. 4 is stored in the data area. In the program validity information, Starting Address represents the starting address acquired in step 103 in FIG. 3, Size represents the size acquired in step 101 in FIG. 3, and Checksum Value represents the checksum value computed in step 102 in FIG. 3.

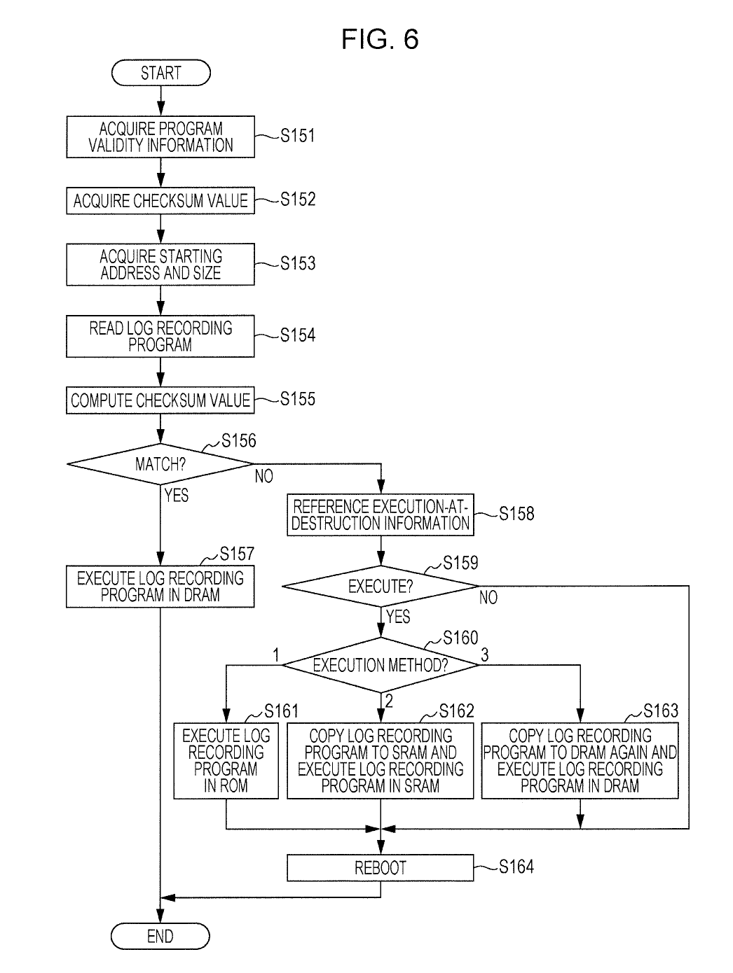

FIG. 6 is a flowchart illustrating an example of operation when the image processing apparatus 10 determines the validity of a log recording program by using program validity information. This operation is performed by the program validity determining unit 14, the memory access switching controller 15, and the reboot unit 17 when an exception handler executed by the exception handler executing unit 13 calls a log recording program. Further, in this operation example, on the basis of the execution-at-destruction information illustrated in FIG. 4, it is determined whether or not to execute the log recording program when the log recording program is destroyed and, in the case of executing the log recording program, which one of the first to third methods is to be used in executing the log recording program.

When an exception handler attempts to call a log recording program, the program validity determining unit 14 acquires the program validity information of the log recording program from the data area of the DRAM 32 (step 151). If the exception handler is to call a log recording program with the starting address in the program area as an argument, the program validity determining unit 14 may acquire the program validity information by retrieving this starting address in the data area of the DRAM 32. If the exception handler is to call a log recording program with the ordinal position in which the log recording program is recorded in the program area, that is, the ordinal position in which the corresponding program validity information is recorded in the program area, as an argument, the program validity determining unit 14 may acquire program validity information corresponding to this ordinal position in the data area of the DRAM 32.

When the program validity information of the log recording program is acquired in this way, the program validity determining unit 14 extracts a checksum value from the program validity information (step 152).

Further, at this time, the program validity determining unit 14 extracts a starting address and a size from the program validity information (step 153), and reads the log recording program from the program area of the DRAM 32 on the basis of the starting address and the size thus acquired (step 154). Then, the program validity determining unit 14 computes the checksum value of the log recording program that has been read (step 155).

Accordingly, the program validity determining unit 14 determines whether or not the checksum value extracted in step 152, and the checksum value computed in step 155 match (step 156).

In a case where these checksum values are determined to match, it is considered that the log recording program in question is not destroyed. Accordingly, the program validity determining unit 14 notifies the memory access switching controller 15 to that effect. Thus, the memory access switching controller 15 executes the log recording program in the DRAM 32 while setting the DRAM 32 as the memory to be accessed as it is (step 157).

In a case where these checksum values are not determined to match, it is considered that the log recording program in question is destroyed. Accordingly, the program validity determining unit 14 notifies the memory access switching controller 15 to that effect. Thus, the memory access switching controller 15 references the execution-at-destruction information defined with respect to the log recording program (step 158).

Then, first, on the basis of the execution-at-destruction information, the memory access switching controller 15 determines whether or not to execute the log recording program (step 159).

In a case where the memory access switching controller 15 determines to execute the log recording program as a result, the memory access switching controller 15 determines by which one of the first to third methods mentioned above the log recording program is to be executed, on the basis of the execution-at-destruction information (step 160).

In a case where the memory access switching controller 15 determines to execute the log recording program by the first method, the memory access switching controller 15 sets the ROM 31 as the memory to be accessed, and executes the log recording program in the ROM 31 (step 161).

In a case where the memory access switching controller 15 determines to execute the log recording program by the second method, the memory access switching controller 15 sets the SRAM 24 as the memory to be accessed, instructs the second loading unit 16 to load the log recording program from the ROM 31 into the SRAM 24, and executes the log recording program in the SRAM 24 (step 162). In this regard, for example, when loading the log recording program from the ROM 31 into the SRAM 24 for the first time, the second loading unit 16 constructs a program execution environment in the SRAM 24. The program execution environment includes exception handlers and a vector table for calling the exception handlers.

In a case where the memory access switching controller 15 determines to execute the log recording program by the third method, the memory access switching controller 15 instructs the second loading unit 16 to load the log recording program from the ROM 31 to the DRAM 32 again while setting the DRAM 32 as the memory to be accessed as it is, and executes the log recording program in the DRAM 32 (step 163).

When the log recording program is executed in this way, the memory access switching controller 15 notifies the reboot unit 17 to that effect, and the reboot unit 17 then reboots the image processing apparatus 10 (step 164).

In a case where the memory access switching controller 15 determines in step 159 not to execute the log recording program, the memory access switching controller 15 does not execute the log recording program, and notifies the reboot unit 17 to that effect. The reboot unit 17 then reboots the image processing apparatus 10 (step 164).

Now, a specific description will be given of data loaded into the SRAM 24 when it is determined to execute a log recording program by the second method through the operation illustrated in FIG. 6.

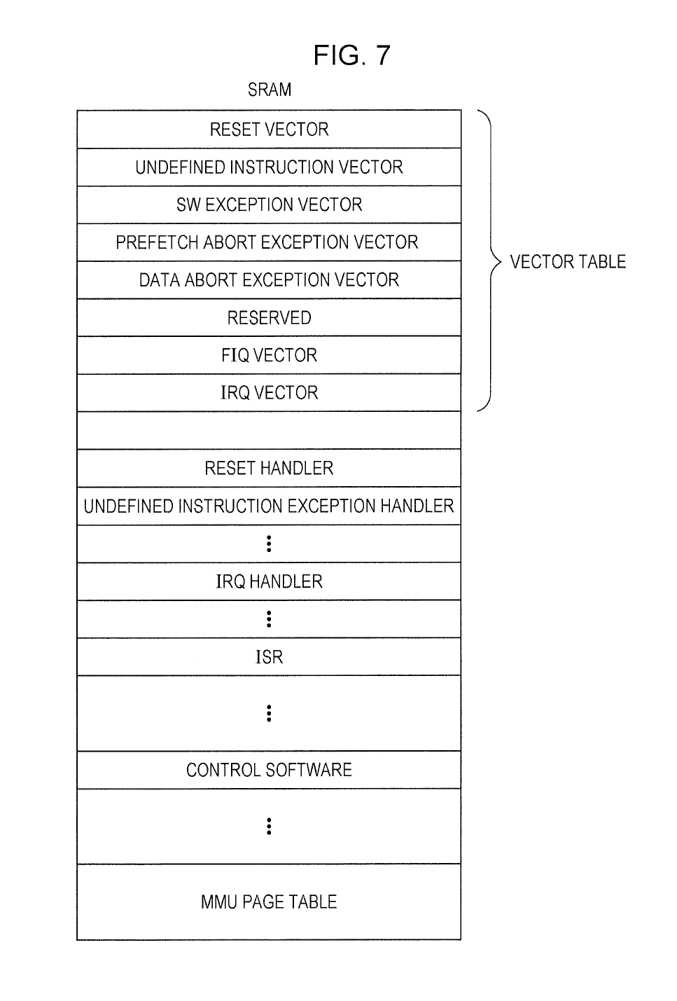

FIG. 7 illustrates data stored into the SRAM 24 at that time. As illustrated in FIG. 7, a vector table is stored in the SRAM 24. The vector table is a table storing vectors from “Reset Vector” to “IRQ Vector”. Normally, each vector begins at address 0 of the ROM 31, and stored at a predetermined address. In this regard, even when loaded into the SRAM 24, each vector is stored at the same address in the SRAM 24, thereby realizing the same program execution environment as that in the case where the vector table is stored in the ROM 31. Further, exception handlers corresponding to individual vectors are also stored in the SRAM 24. In each vector of the vector table, the address of the corresponding exception handler is stored. By referencing a vector corresponding to an exception generation notification from the exception generator 23, an exception handler corresponding to the vector is executed. Further, control software is stored in the SRAM 24. This control software controls various functional units of the image processing apparatus 10 such as the image reading unit 34 and the image forming unit 35. The log recording program loaded into the SRAM 24 from the ROM 31 in step 162 is also stored while being included in this control software. As a result, when an exception handler stored in the SRAM 24 is executed, the log recording program stored in the SRAM 24 is called. Furthermore, a page table to be referenced by the MMU 22 (see FIG. 1) is also stored in the SRAM 24.

A program for realizing the exemplary embodiment may not only be provided by a communication section but may be provided while being stored on a recording medium such as a CD-ROM.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A state information recording apparatus comprising:
a copying section that copies a recording program from a first memory to a second memory, the recording program recording state information related to a state of the state information recording apparatus into a non-volatile memory, the first memory being a memory into which the recording program is stored before the recording program is executed, the second memory being a memory into which the recording program is stored when the recording program is executed;
a detector that detects occurrence of a fault in the state information recording apparatus;
a determining section that determines whether or not the recording program copied to the second memory is destroyed, in response to detection of occurrence of the fault;
a recording section that records the state information to the non-volatile memory by one of
executing the recording program in the second memory in a case where it is determined that the recording program copied to the second memory is not destroyed, and
executing the recording program stored in the first memory in a case where it is determined that the recoding program copied to the second memory is destroyed; and
a reboot section that reboots the state information recording apparatus after the state information is recorded to the non-volatile memory.

2. The state information recording apparatus according to claim 1, wherein in the case where it is determined that the recording program copied to the second memory is destroyed, the recording section records the state information to the non-volatile memory by executing, in the first memory, the recording program stored in the first memory.

3. The state information recording apparatus according to claim 2, wherein in the case where it is determined that the recording program copied to the second memory is destroyed, the recording section records the state information to the non-volatile memory by executing, in the first memory, the recording program stored in the first memory, if the recording medium is a recording medium determined in advance as being executable in a restricted environment of the first memory.

4. The state information recording apparatus according to claim 1, wherein in the case where it is determined that the recording program copied to the second memory is destroyed, the recording section records the state information to the non-volatile memory by copying the recording program stored in the first memory from the first memory to a third memory, and executing the recording program in the third memory, the third memory being a memory that is not affected by destruction of the recording program copied to the second memory.

5. The state information recording apparatus according to claim 4, wherein in the case where it is determined that the recording program copied to the second memory is destroyed, the recording section records the state information to the non-volatile memory by executing, in the third memory, the recording program stored in the first memory, if the recording medium is a recording medium determined in advance as being executable in a restricted environment of the third memory.

6. The state information recording apparatus according to claim 1, wherein in the case where it is determined that the recording program copied to the second memory is destroyed, the recording section records the state information to the non-volatile memory by copying the recording program stored in the first memory from the first memory to the second memory again, and executing the recoding program in the second memory.

7. The state information recording apparatus according to claim 1, wherein the determining section determines whether or not the recording program copied to the second memory is destroyed by comparing first characteristic information and second characteristic information with each other, the first characteristic information being computed by a predetermined procedure prior to detection of occurrence of the fault from the recording program copied to the second memory, the second characteristic information being computed by the predetermined procedure in response to detection of occurrence of the fault from the recording program copied to the second memory.

8. A non-transitory computer readable medium storing a program causing a computer to execute a process, the process comprising:
copying a recording program from a first memory to a second memory, the recording program recording state information related to a state of a state information recording apparatus into a non-volatile memory, the first memory being a memory into which the recording program is stored before the recording program is executed, the second memory being a memory into which the recording program is stored when the recording program is executed;
detecting occurrence of a fault in the state information recording apparatus;
determining whether or not the recording program copied to the second memory is destroyed, in response to detection of occurrence of the fault;
recording the state information to the non-volatile memory by one of
executing the recording program in the second memory in a case where it is determined that the recording program copied to the second memory is not destroyed, and
executing the recording program stored in the first memory in a case where it is determined that the recoding program copied to the second memory is destroyed; and
rebooting the state information recording apparatus after the state information is recorded to the non-volatile memory.

9. A state information recording method comprising:
copying a recording program from a first memory to a second memory, the recording program recording state information related to a state of a state information recording apparatus into a non-volatile memory, the first memory being a memory into which the recording program is stored before the recording program is executed, the second memory being a memory into which the recording program is stored when the recording program is executed;
detecting occurrence of a fault in the state information recording apparatus;
determining whether or not the recording program copied to the second memory is destroyed, in response to detection of occurrence of the fault;
recording the state information to the non-volatile memory by one of
executing the recording program in the second memory in a case where it is determined that the recording program copied to the second memory is not destroyed, and
executing the recording program stored in the first memory in a case where it is determined that the recoding program copied to the second memory is destroyed; and
rebooting the state information recording apparatus after the state information is recorded to the non-volatile memory.
